(19) United States
(12) Patent Application Publication
(10) Pub. No.: US 2002/0120757 A1
(43) Pub. Date: Aug. 29, 2002

(54) Controlled access system for online communities

(76) Inventors: Stephen B. Sutherland, Markham (CA); Dale M. Wick, Toronto (CA)

Correspondence Address: DENNISON ASSOCIATES, 133 RICHMOND STREET WEST, SUITE 301, TORONTO, ON, M5H 2L7, CA

(21) Appl. No.: 10/067,962

(22) Filed: Feb. 8, 2002

(30) Foreign Application Priority Data
Feb. 9, 2001 (CA) 2,335,395

(51) Int. Cl. G06F 15/16

(52) U.S. Cl. 709/229; 709/203

(57) ABSTRACT

A system for granting group permissions to specific resources to users in online communities such as the Internet.

### FIELD OF THE INVENTION

The present invention relates to a system for managing group permissions to dynamically created and shared resources in online communities, using open standards for email and the World Wide Web, in particular, over the Internet or intranets with such applications as online photo communities.

### BACKGROUND OF THE INVENTION

Although widely used and understood concepts of network resource management of traditional resources of file and print servers using protocols such as “samba” and Sun Microsystem's “NFS” (network file system) have met demands of traditional network users, new challenges of typically Internet-based online communities require a different approach to resource administration.

Traditionally, the formation of groups and allocation of network resource access permissions has been done centrally by a relatively small set of specially trained administrators who typically define only a handful of relatively static groups (or classes of users) using minimal automation. To be able to centrally create such groups, administrators must be given “total knowledge” of the system—including a detailed list of all users with which to create such groups and a list of all network resources. This use of groups to categorize users to give fairly standardized permissions for file access, update and deletion as well as printer control greatly simplified administration of such traditional network resources.

With online communities, there tends to be not hundreds to thousands of users, but tens of thousands to millions of users. These users wish to create many impromptu groups with small or large numbers of members each. Groups may last for hours, days, weeks or even years and would come together to share folders of documents, selected information, photo albums, message lists, or other data. Ideally, to allow these groups to form, each user would become a “mini-administrator” that can add access to others for their own or group content.

One current example of an online community faced with these challenges is that of ICQ (short for “I seek you”). With ICQ, the online community is formed around the idea of each user having a group of friends that they monitor information about. Effectively the resource is the ability to send messages to other selected ICQ members. To enroll new members in your group of contacts (and similarly in their group of contacts), the ICQ system follows one of three strategies: (i) publishing your ICQ member ID on a business card or web site so that others will be able to identify you; (ii) emailing an invitation to join which contains your ICQ ID; or (iii) searching a public directory to find the ICQ ID someone you wish to contact. The ultimate process in all three strategies requires that your ICQ number is received by the prospective member of your group. Then they enter that in their ICQ contact list, and you are asked to verify their admission.

In order to allow ad hoc groups to form and share specific information, it is apparent that the current state of the art for traditional network management is to either distribute the owner's account and password and therefore all permissions for a given shared resource to a target group, or to create resources freely accessed by all users. For online communities, the state of the art in true ad hoc group creation is to publicly publish all users, contact information such that anyone can request entry into a group. Alternatively, such sites publish the content to the Internet world at large.

It is clear that neither the approaches used in traditional network management, nor those currently deployed by online communities, effectively bridge the gap for ad hoc group creation between centrally managed secure resource access and unsecured open access.

### SUMMARY OF THE INVENTION

The invention defines a system permitting many non-trusted administrators, with minimal knowledge of other system users, to securely create ad hoc groups from both existing system users and those previously outside the system and manage corresponding resource permissions for such groups and in some cases, for individuals within such groups.

The system identifies four main components: a resource, the owner (or owners) of the resource, an existing member user and a non-member user.

In the simplest case, the owner of a resource selects the level of access for the new group when it is created. The owner then requests the system to generate an appropriate sign-up URL (as defined below) to be sent to the email addresses of the prospective member and non-member users. Each user receives the sign-up URL in email. The user then clicks on the sign-up URL which links to one of two corresponding web pages. For members, they are asked to login. On successful login, the database is updated with their group membership activated. For non-members, they are asked to sign up and then they are added to the group membership. The user is granted the group permissions offered by the owner.

There are a number of possible different refinements to the above process, depending on the demands of the ad hoc group which may determine the composition and thus corresponding behavior of the sign-up URL. In the list below, examples are provided to illustrate both the breadth and scope of possible uses for such sign-up URL's.

1) The sign-up URL in the simplest case only contains a coded reference to the group that the prospective member (or non-member) has been invited to join. For example, a photographer might have a group of albums of professional work targeted at different audiences with certain photographs appearing in multiple albums. In this case, the photographer would classify his clients into groups according to their tastes and only invite each client into one group containing related albums.

2) The sign-up URL might include coded references to multiple group invitations. It is conceivable, for instance, that a real-estate agent might create a resource (an album typically) for each property being offered. These albums would then be offered to selected groups (for example, the agent might have the “Bass Lake Cottage Group” and the “Pine Lake Cottage Group” and the “Sunset City Group”—if the agent listed a cottage near both Bass and Pine Lakes, it's album might be included in both groups). Likewise, prospective clients might be invited to view a set of such resources by receiving a sign-up URL automatically placing such client into the “groups” for properties that the agent feels the client will have an interest. In this example, the sign up URL might invite a prospective client into both the Bass Lake and Pine Lake Cottage Groups simultaneously.

3) The sign-up URL may include a time expiry embedded. For example, maybe the group will only accept new members for a given period—perhaps it's a “you must act fast” promotional scenario.

4) The sign-up URL may include a unique identifier which prevents its use more than once, thus preventing an invitee from forwarding the URL to other uninvited parties.

5) The sign-up URL may include encoded information about the prospective group member it has been emailed to which would prevent others from using it to logon and register for a group. The sign up URL could, in this case of an unregistered system user, force such prospective user to register only with the e-mail address originally target

6) The sign-up URL may include a code to notify the resource owner when it is used by a prospective member. It might also be coded to inform the resource owner who used it to be added to the group.

7) The sign-up URL may include a code to check, before confirming registration of a prospective member, that the invitation to join a group has not been retracted by the resource owner.

8) The sign-up URL may include a code to grant the prospective member of a group special access to the resource beyond that given to most members of the group or to provide more restrictive access than that given to most members.

In any of the above cases, it can readily be seen that any of the materials encoded within the sign-up URL may be replaced with a unique identifier (a “pointer”) referencing a database table entry where the actual variable data might be stored. In this case, when the prospective member clicks on the URL, the server makes a database lookup based on the pointer encoded into the URL to ascertain the desired action based on fields in the database.

In accordance with one embodiment of the present invention, a unique internet photo sharing community may be constructed. The process of sharing albums (the resource) in traditional photo sharing communities is cumbersome for a number of reasons:

1) The owner of a set of pictures typically creates an album and must assign a password. The owner has a significant task in managing album names and passwords since each album must have a different password unless he/she wishes previous invitees to simply have access to all his/her albums.

2) The owner then emails the album name and password to friends. Each and every time he/she has a new album to share, and invitation must go out with the album name and password—a laborious task.

3) Friends receive this email and must manually note the name of the album and password on a piece of paper or some other list they keep with their computer as there is no way to access all albums they have been invited to (likely from many different people) with one password or even see all their invited album names in one short list on the photosharing site or visually represented together on a screen with print albums and images.

4) The owner of the album has no knowledge if their invitees accept their invitations or even if anyone has looked at the album.

5) There is also no way that the owner of the album can control who receives the invitation as it may be forwarded without the owners knowledge—and anyone with the album name and password may access the album.

6) There is no way for the owner of an album to retract an invitation. Say, for example that someone was posting rude remarks against certain photos within the album. Although the album owner would see the username of the individual, there would be no way to restrict such person without changing the password to the album and thus having to inconvenience everyone else.

These factors are severely restricting the success of traditional photosharing sites and are addressed in the following steps defining one embodiment of the present invention:

1) In this invention, a member of a photosharing community can create named groups of people by adding individuals email addresses or userids to the group. The system would automatically match email addresses with existing userids.

2) The member then gives access to one or more albums to each group and sends an email containing the invitation URL to the group.

3) On receipt of the URL, each invited member is given an option to accept membership in the group and thus access to group albums. The URL may only be used by those to whom it is addressed.

4) Invited members use their own password to access shared albums and see a list of all their personal albums and any shared albums at their will. Thus, each member of the photo sharing community has only one password to remember, and only one location to check to see a list of albums and groups.

5) The owner of the group may retract access by any invited member. The owner can also see if invited members have accepted the invitation and may re-invite users.

6) The owner of a group may offer extended access to any member, this allows for multiple group members to be able to upload images for example.

7) From time to time, new albums may be added to, and older albums may be removed from, the group access. Each time a group member checks his/her group albums, the new albums will automatically appear—no notice from the group owner is required unless requested by group members.

Comparing the effectiveness of the above with the traditional photo sharing site is illustrative: A ski club, for example, could add all its members to a group on the photo sharing site, ensuring that the membership secretary dynamically added and removed members throughout the season (new members would get invitations to the group). Each ski team would then post one or more albums throughout the season as “team captains” would have album create access within the group. Members would then have access to these albums on a virtually instantaneous basis just by checking albums posted to their Ski Club group. With the traditional photo sharing sites, constant emails would have to go out each time a new album was posted and such emails would have to contain the album name and password. If multiple “team captains” were posting albums, each would have to know all the email addresses of all members of the club. If club membership changed, all these email lists would have to be continually updated. No common “Ski Club” group would exist where all club albums could be found by members. Essentially, the administration of the ski club photosharing would become a batch process versus the truly dynamic, spontaneous process possible under the invention herein.

### BRIEF DESCRIPTION OF THE DRAWINGS

Preferred embodiments of the invention are shown in the drawings, wherein:

FIG. 1 is a topological view of a traditional file sharing system;

FIG. 2 is a topological view of the ICQ member system;

FIG. 3 is a topological view of the online photo community;

FIG. 4 is a state diagram of a trusted administrator group system;

FIG. 5 is a state diagram of the ICQ member system;

FIG. 6 is a state diagram of the online photo community

FIG. 7 is an example login screen for a member “dissident”;

FIG. 8 is a screen showing the groups of the member “dissident”;

FIG. 9 is a screen showing how to create a group;

FIG. 10 is a screen showing how people are invited to join a group;

FIG. 11 is a screen showing the new group “sample group” and the albums shared therewith;

FIG. 12 is a screen providing feedback with respect to invitations sent by e-mail to individuals;

FIG. 13 shows an e-mail invitation received by the non member dmwick;

FIG. 14 is an initial screen used when dmwick uses the URL contained in the e-mail;

FIG. 15 is a screen allowing dmwick to set up an account as a new member;

FIG. 16 is a screen allowing the new member to view the albums available to him, namely; his own first album and the shared albums of sample group “dissident”;

FIG. 17 is a screen showing details of the sample group/dissident when actuated;

FIG. 18 is a message to the member “dissident” that the new member “patent” has accepted his invitation;

FIG. 19 is a status screen allowing the member “dissident” to overview the status of his group “sample group”; and

FIG. 20 is a screen allowing removal of members from a group.

### DETAILED DESCRIPTION OF THE PREFERRED EMBODIMENTS

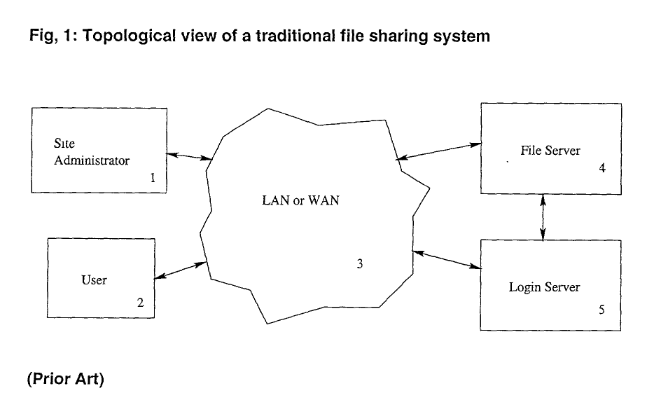

FIG. 1 shows a traditional prior art file sharing scheme over a Local Area Network or Wide Area Network 3. There can be multiple file servers 4 connected to a central login server 5 who share files on a per user 2 basis. The Site Administrator 1 controls who has access to what resources.

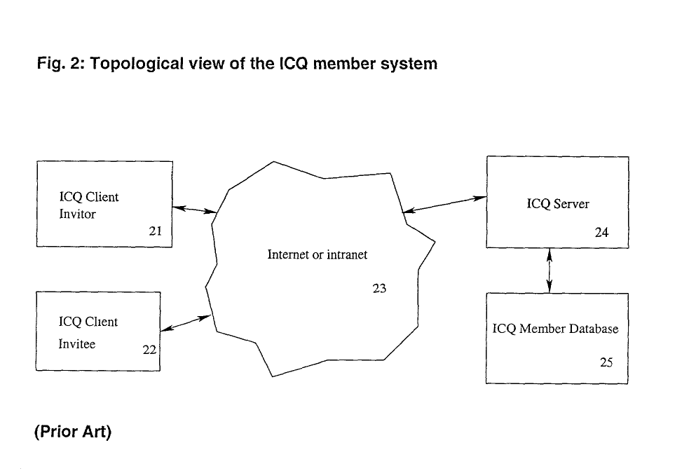

FIG. 2 shows a similar prior art arrangement for the ICQ™ online chat community, based over the Internet or intranet 23 instead of a LAN or WAN 3 of FIG. 1. Instead of a file server 4 there is an ICQ Server 24 and there is a Member Database 25 instead of Login Server 5. Both login server 5 and file server 4 and ICQ server 24 represent the resource. Both login serve S and database 25 holds the user profile with the list of the groups that each user is a member of. With FIG. 2, an individual member 21 can invite a new member 22 to his or her contact list. The contact list can be viewed as a group that the invitee belongs to in the same way that a user 2 of FIG. 1 can belong to a number of groups.

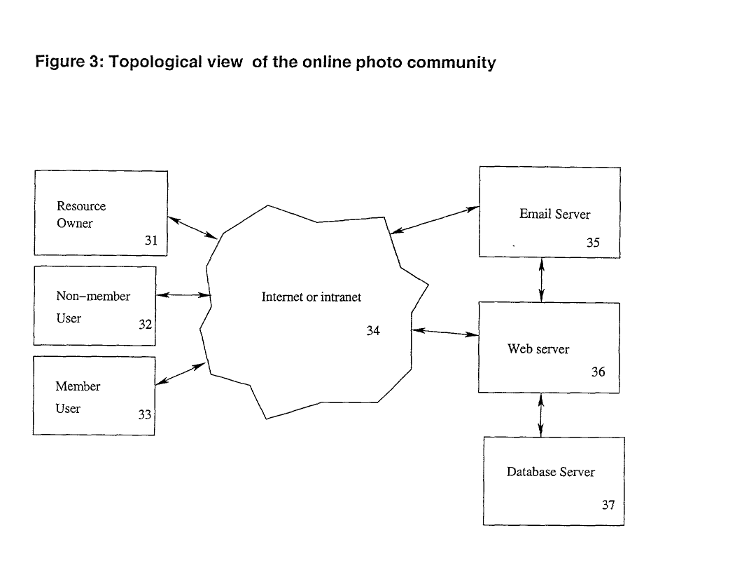

FIG. 3 shows the online photo community topology according to the present invention. The Resource Owner 31 becomes equivalent to the ICQ Invitor 21. The invitee 22 of FIG. 2 is equivalent to a Non-member User 32 or Member User 33 of FIG. 3. The network (internet or intranet) is 34. The database server 37 corresponds to the ICQ member server 25.

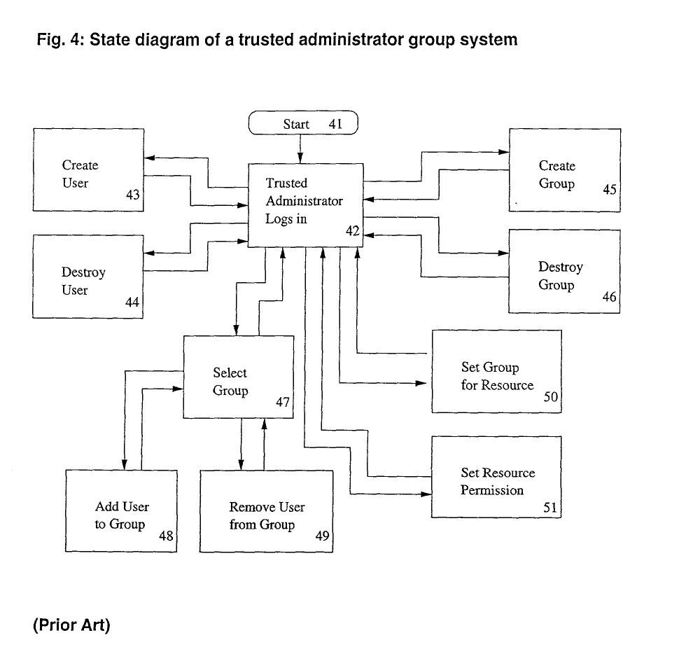

FIG. 4 shows the administration state diagram. The Start 41 is followed by a log in 42 central state. From here the trusted administrator can create or destroy users and groups 43, 44, 45 and 46 as well as set the group for each resource 50 and change the permission on a resource 51. Finally to work with groups, the administrator needs to move from state 42 to 47, selecting a particular group to work on. From state 47, the administrator can add users 48 or remove users 49. Because the administrator is trusted, these actions happen without confirmation.

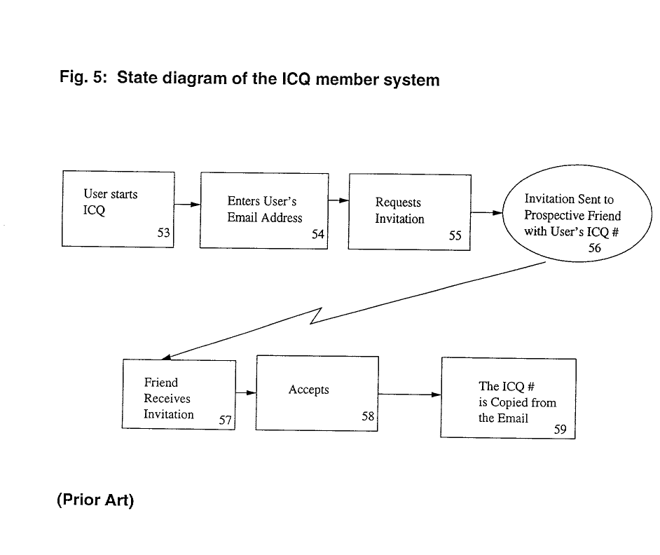

FIG. 5 shows the ICQ contact sign up scheme for the case where the potential contact is not in a publicly listed directory. In states 53, 54 and 55 the invitor is in control. The invitation is created in 55 and is emailed in 56 by the ICQ server or other email system. From step 57 to 58 the invitee takes over. In step 59 the ICQ number is copied into their client software, and the normal conformation steps take place.

In FIG. 6 we see the states involved in the online photo community. The diagram starts at state 61. First, the Resource Owner logs in at State 62 (for example the owner of photos in the online community logs in). This is similar to State 42 of FIG. 4. From here the resource owner has access to the groups created by him or her. That list of groups can be maintained using states 65 and 66.

Also State 70 and 71 allow resource permissions and group access to be altered. Again, the resources are limited to owned resources, unlike 50 and 51 of FIG. 4. In a file system the resources are typically files and the permissions are reading, writing, executing, and deleting. With an online photo sharing community, the permissions allow for reprints, cropping, annotation, image processing, reusing in a collague or total reuse permission.

Finally a group is selected in state 67. In 69, the owner is then able to remove users from the group in a manner similar to state 49. At state 68, the owner invites a user to the group.

The method followed from state 68 involved sending a special URL which is created at state 63 and simplifies joining of the group. This URL contains a unique identifier plus some randomness for security. This allows for a number of options for encoding the email address of the prospective user or a serial number that links back to a database. The cookie can either be set to expire or be unique to a particular email address or member user's account. In state 64 the cookie can be recorded in the server side database and a potential expiry date can be recorded.

Then at State 72, the URL is sent by email denoted by the line between 72 and 73, and the Resource Owner is returned to State 67.

At state 73 a member or non-member user receives an email containing a URL with a special cookie. Members follow the path 74 to 75 to become logged in, whereas Non-members follow the path 76 to 77 to log in. In either case the cookie is retained by the web browser through these sign up or log in procedures. Members could be optionally auto logged in via a log in cookie. Non-members could be allowed special viewing privileges without joining as a member. In any case, the group joining cookie is carried through to the server in State 78 where the member is automatically added to the group.

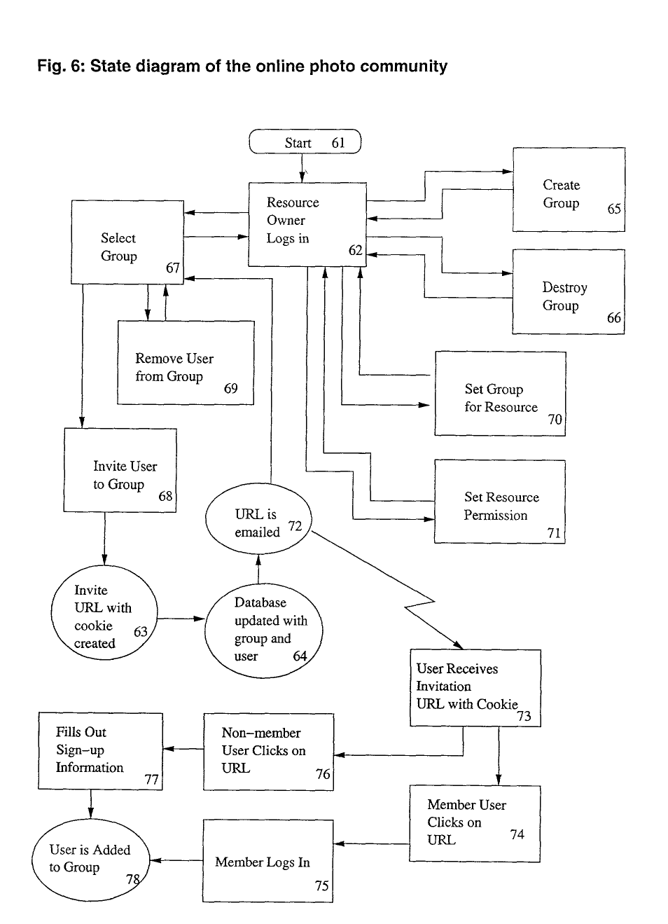

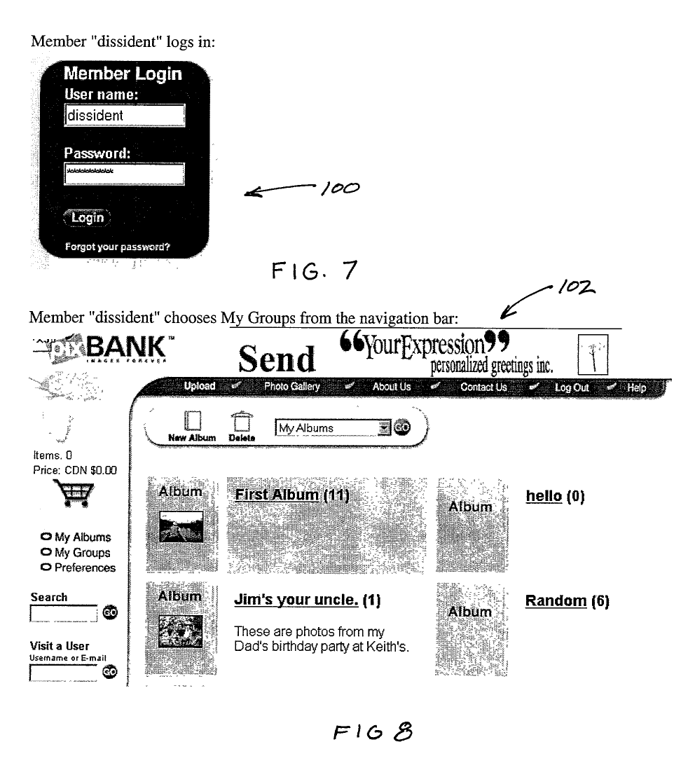

The system and method of the present application allows a web server to be configured to allow a host of users to become separate group administrators where each administrator is associated with at least one common resource that he wishes to make available to users of his choice. The web server is designed such that the group administrator can log in and is directed through a series of web pages (shown as FIG. 7 through 20) to invite new users of his choice to join the group and to also allow this group administrator to set different privilege levels with respect to each invited user.

A database associated with the web server records the particulars of users and invited users in the database associated with a URL which is provided to the users and which is customized to allow the database to know the privilege level. The group administrator can modify his common resource and extend the content thereof, making it available to all members of the group without changing the relationship with the various users of his group.

Users contact the web server using the URL and merely complete a login procedure with a common password protection preferably being present (FIG. 7). This is basically a single security step to provide access to the web server with the authorization associated with the common resource being maintained with the database. In this way, the group administrator can increase and/or limit the access a user has and the privileges that the user has. With this arrangement, the web server allows the group administrator to effectively preauthorize users which he has decided to invite to his group and preferably, the URL which is provided to the user includes in part thereof, a code which is used by the web server to determine the privileges and common resources that the user has access to.

Both the group administrator and the various users access the web server and full control for the common resource of the group administrator lies with the group administrator and does not require interaction with personnel associated with the web server. Basically, the web server has been configured to provide this control to the group administrator and also allows this group administrator in a simple way, to invite users to share his particular common resource and to simplify the interaction by the group administrator with the web server, as well as the individual users with the web server.

This system and method has particular application with respect to digital photography and the storing of digital photo albums or digital photo content on a web server where a particular group administrator controls access to his particular digital content. Access to the particular group administrator's common resource is controlled to whatever degree that the group administrator wishes. If a high degree of control is desired, the group administrator can have the web server create a unique URL for each possible user of that resource and the different privilege levels for that particular user can be maintained in a database associated with the web server and the particular URL. In other cases, unrestricted browsing can be possible.

With respect to the specific example of photographic digital data, different privileges could include browsing of the content to selection, printing of certain portions of the data to editing and/or forwarding to other parties. These privileges can be modified by the group administrator and the system also allows the group administrator to set a certain time period during which access is allowed. For example, the URL could expire at a particular point in time and if the previously authorized user tries to access the common resource after the expiry time period, the database will recognize that this URL has expired and deny access. This system allows a very flexible approach where basically unskilled group administrators can form and provide information to users of their choice with a degree of security that they have selected or accepted.

The system is easy to use for the group administrator as well as for individuals who have been invited to join a group as the web server basically uses the URL to simplify contact and control the privileges of a user in accordance with information determined by the group administrator.

The above system has particular application with respect to digital photography, however, it is certainly not limited to this application. Basically, the system allows simplified control access and management of a database of the group administrator. This arrangement allows many unrelated group administrators to store their information on a web server and limit access to their information to users which they have effectively preauthorized. The web server can host many unrelated common resources and have many different group administrators who are all unrelated. Such a centralized system can be extremely cost effective while still providing the individual group administrators with full control and flexibility with respect to expansion of their information, and expansion of their users and the various privilege levels and number of privileges available to their users.

Thus this system is cost effective as many different users have access to a system which on a single or small user base would not be cost effective.

FIG. 7 shows the login screen 100 for the user dissident. This user has entered their password and has opened the screen 102 shown in FIG. 8. The member dissident has then opened using the navigation control on the left hand side “my groups” to move to the screen shown in FIG. 9.

FIG. 9 shows the navigation bar 104. and the member actuates the control “create group”. This produces the screen 106 where the dissident in this case will name the group “sample group”.

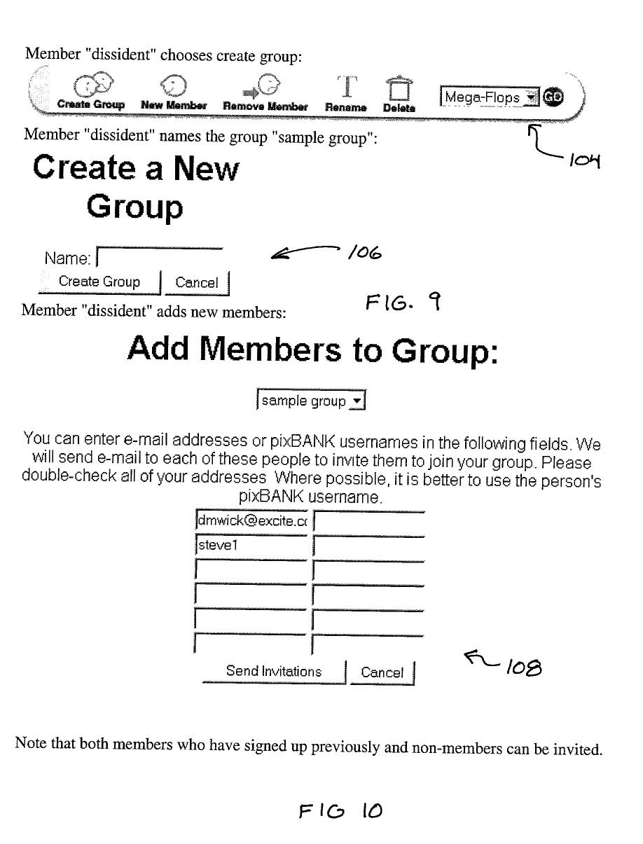

In FIG. 10, various members are added to this new group as shown in screen 108 where two people are being invited to the group, namely; dmwick at a certain e-mail address, and stevel who would be a member of PIXBANK.

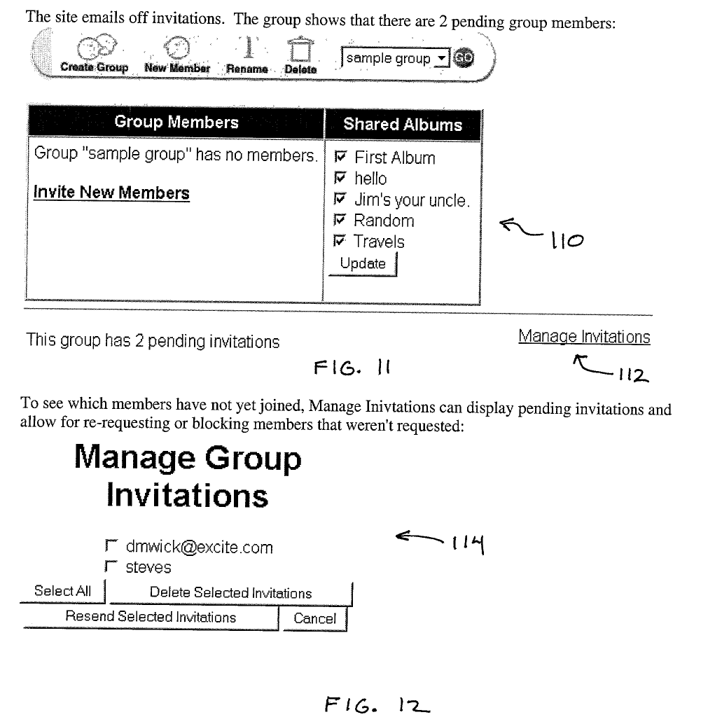

FIG. 11 shows a status screen 110 stating that the group “sample group” has no members and also shows what albums are available to be shared by this group. There is also a report that this group has two pending invitations. By actuating control 112, the user moves to screen 114 shown in FIG. 12. The two pending invitees are listed and certain management controls are possible.

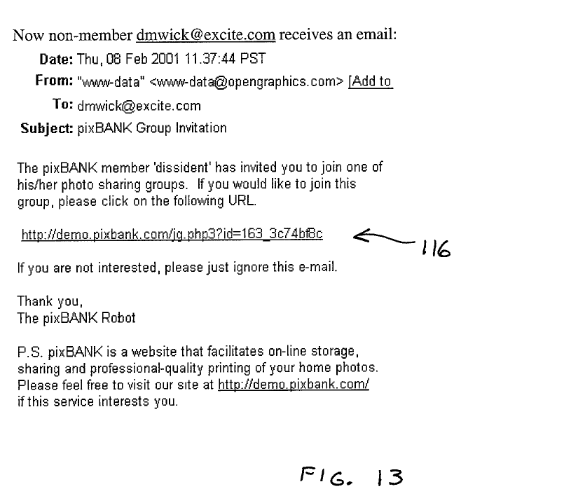

FIG. 13 shows an e-mail which has now been received by the non member dmwick. Within the e-mail, is the URL 116 which provides a simple means for the invitee to respond to the invitation. Actuation of the URL will take him to the website and take him to the login screen.

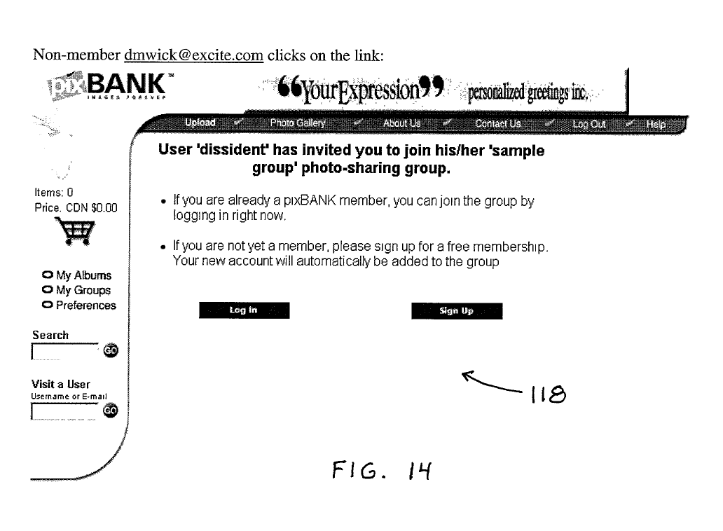

The login screen is shown in FIG. 14 as 118. Instructions are provided allowing login based on a new member or login based on an existing member.

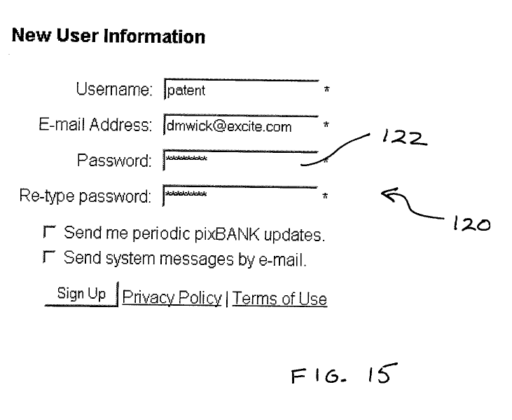

Screen 120 of FIG. 15 shows the login procedure for the new member dmwick. As can be seen, the new member enters a password of his choice at 122 and basically, this is the only information he is required to remember. The URL which he used has already registered certain information which he is entitled to share. In addition, as a member, he can store his own digital records on the site, and also proceed with his own group, if he so wishes.

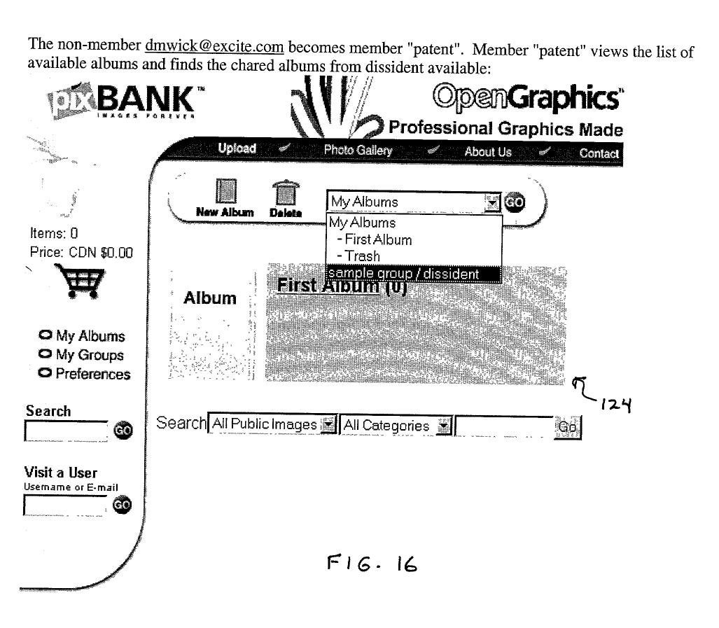

After the login at FIG. 15, the new member dmwick is taken to the screen 124 of FIG. 16 and decides to look at the sample group that he has been invited to join. This then takes him to the shared albums of the sample group/dissident shown as 126 in FIG. 17. He can then review any of those albums according to whatever privileges have been assigned to the original administrator.

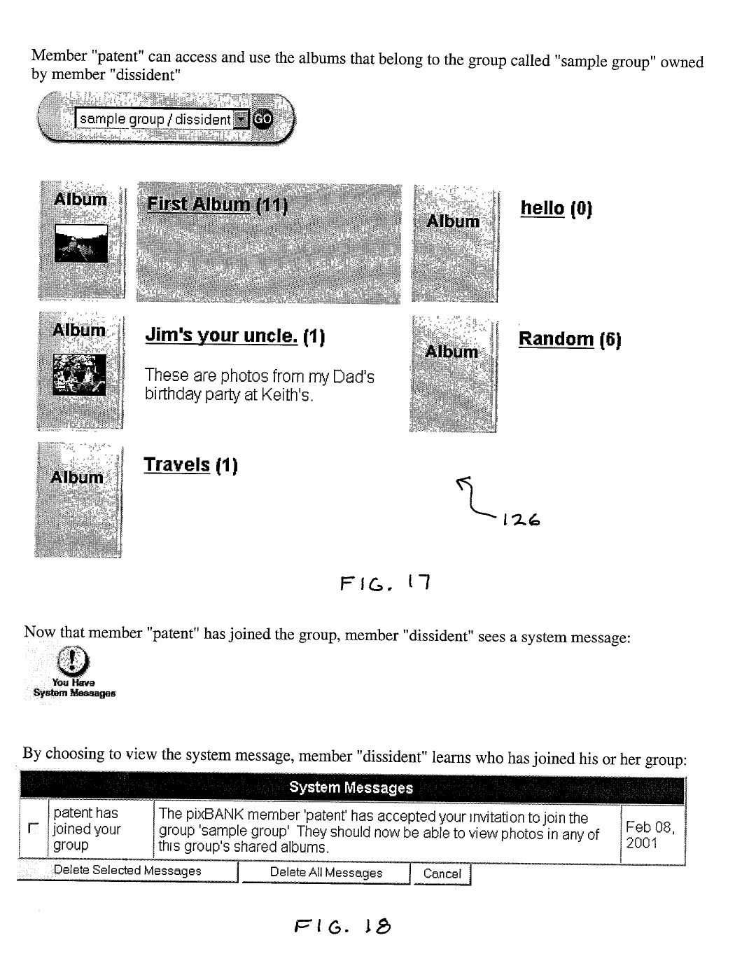

FIG. 18 shows a system which is provided back to the owner of the sample group. In this case, the member patent is the name that was entered by the invitee who received the e-mail address to dmwick.

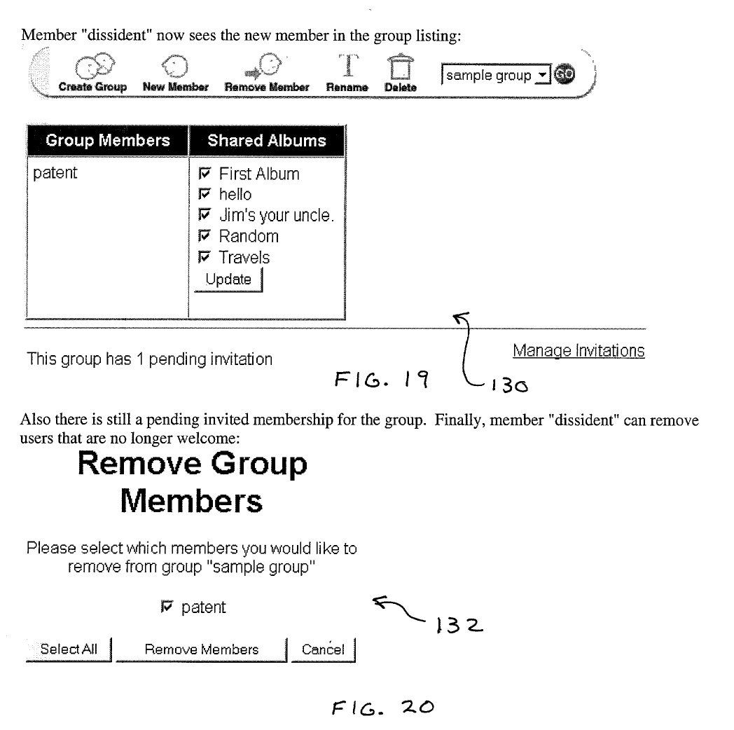

FIG. 19 is a further status screen 130 which has been accessed by the member dissident and shows that the new member patent has entered the group and the group has one pending invitation. Screen 132 of FIG. 20 is another administrative screen which allows the administrator dissident to remove certain members from his group.

As can be seen, the system is quite intuitive and allows a user to quickly become familiar with the system. It also allows each user to become a group administrator and thereby further extend the number of users to the system. In this way, the number of users of the system can greatly expand as each member has the easy capability of forming a group and inviting both members and non members to join his newly formed group.

Although various preferred embodiments of the present invention have been described herein in detail, it will be appreciated by those skilled in the art, that variations may be made thereto without departing from the spirit of the invention or the scope of the appended claims.

The Embodiments of the invention in which an exclusive property or privilege is claimed are defined as follows:

1. A group permissions system that minimizes the knowledge needed by a group administrator of other users and allows for new members previously outside the system, implemented using email and the World Wide Web with a sign up system involving a special URL which contains a group sign up cookie which is passed in the web browser through the log in or sign up to add the permissions for the group to that user.

2. A system as claimed in claim 1 wherein the URL is customized to pertain to only one user.

3. A system as claimed in claim 1 wherein the URL is customized to invite a recipient into multiple groups simultaneously.

4. A system as claimed in claim 1 where the URL expires after a specified time period.

5. A system as claimed in claim 1 wherein the URL is tracked such that it can be used only once.

6. A system as claimed in claim 1 wherein the non-member user can browse the controlled resource without joining as a user.

7. A system as claimed in claim 1 wherein the URL leads an unregistered site user to a registration screen where only the originally target e-mail address can be used for registration purposes.

8. A photosharing community where users share albums with groups of friends or associates through invitations which do not require invited members to use unique passwords on each shared album.

9. A photosharing wide area computer network comprising a web server storing digital images associated with particular users and allowing each particular user to authorize others to access the digital images of the particular user, said web server providing each user with an invitation procedure for inviting others to access the images controlled by the user, said invitation procedure including creating an invitation which includes an authorization segment and forwarding the invitation electronically to a designated invitee at a particular address, said designated invitee using said invitation to contact the web server and provide access to said images controlled by the user in accordance with said authorization segment.

10. A photosharing wide area computer network as claimed in claim 9 wherein invitees access said web server using a computer and the internet.

11. A photosharing wide area network as claimed in claim 9 wherein upon contact with the web server any recorded user has a listing of photo albums and said photo albums include personal photo albums and photo albums which the user and received authorization to share.

12. A method of providing controlled access to a common resource to be shared by a plurality of users where said common resource is available on a Web server available on the world wide web, said method comprising
recording a group sign up authorization cookie associated with said common resource with said Web server,
creating a customized URL which contains said group sign up authorization cookie,
providing said customized URL to a new user,
using a Web browser and said customized URL to initiate access to said common resource provide on said Web server and passing said group sign up authorization cookie through said Web browser to said Web server,
confirming said passed group sign up authorization cookie has been previously recorded and allowing access to said common resource associated with said group sign up authorization cookie.

13. A method as claimed in claim 12 wherein said customized URL is provided to said new user using e-mail.

14. A method as claimed in claim 12 wherein the URL is customized and uniquely identifies the user.

15. A method as claimed in claim 12 wherein said URL remains valid for a specific time period.

16. A method as claimed in claim 12 including a log in procedure which is part of said step to initiate access to said common resource.

17. A method as claimed in claim 12 wherein said common resource is a photosharing resource.

18. A method as claimed in claim 12 wherein said web server allows users to establish their own common resource and determine the users who have access thereto by determining what users receive the customized URL.

19. A method of providing controlled access to a common resource to be shared by a plurality of users where said common resource is available on a computer server available on the world wide web, said method comprising
an initiating user communicating with said computer server and requesting thereof the creation of a common resource with controlled access administered by said initiating user,
said initiating user establishing said common resource with said computer server,
recording a group sign up authorization cookie associated with said common resource with said computer server,
creating a customized URL which contains said group sign up authorization cookie,
providing said customized URL to said initiating user for distribution to new users of his choice,
said initiating user providing said customized URL to new users,
said new users using a Web browser and said customized URL to initiate access to said common resource provided on said computer server and passing said group sign up authorization cookie through said Web browser to said computer server,
said computer server confirming said passed group sign up authorization cookie has been previously recorded and allowing access to said common resource associated with said group sign up authorization cookie.

20. A method as claimed in claim 19 wherein said initiating user can establish different access privileges to different users or groups of users by establishing different URL's.

21. A method as claimed in claim 17 wherein each user to access said common resource additionally completes a sign in procedure including the entry of a password.
